(19) United States
(12) Patent Application Publication
(10) Pub. No.: US 2002/0073098 A1
(43) Pub. Date: Jun. 13, 2002

(54) Methodology and system for searching music over computer network and the internet based on melody and rhythm input

(76) Inventors: Lei Zhang, Fremont, CA (US); Haijing Wang, Fremont, CA (US); Zhijiang Han, Urbana, IL (US)

Correspondence Address: Lei Zhang, 43555 Grimmer Blvd, M2112, Fremont, CA, 94538, US

(21) Appl. No.: 09/794,609

(22) Filed: Feb. 27, 2001

Related U.S. Application Data
(60) Provisional application No. 60/185,566, filed on Feb. 28, 2000.

(51) Int. Cl. G06F 7/00

(52) U.S. Cl. 707/104.1

(57) ABSTRACT

This invention provides a methodology and system to search music information over a computer network, especially the Internet, based on melody and rhythm of a piece of music, without the knowledge of any textual information of the music. The system is composed of three components, database, client programs and server programs. User inputs melody and rhythm to the system through client programs. The input is translated to a melody and rhythm key. This key is used to perform a search within the database. Server program performs the search.

### REFERENCE TO A MICROFICHE APPENDIX

Not applicable.

### BACKGROUND

1. Field of Invention

This invention relates to multimedia information search, specifically music information search, over computer networks and the Internet.

2. Description of Prior Art

Computer network, especially the Internet, has become a popular media to distribute music in digital format to network users. Also, computer network and the Internet have been used intensively to advertise music related information. Digital music records and related information are stored in centralized or distributed databases on computers connected to a network. People who have computers connected to the same network can search these databases from their local computers. Based on the search result they can retrieve additional information of the music from the remote database or purchase the music electronically.

Existing search methodologies are based on textual information of a piece of music. People who perform music search (music searchers) need to know one or many of the following textual information: title of the music, artist, lyric, category, or other information in text format. People who provide music information or digital music records (music providers) offer text based searching method to music searchers. Textual based searching services offered by Internet music information providers can be found at following web sites: music.yahoo.com, music.lycos.com, www.amazon.com, www.mp3.com, www.cdnow.com, www.napster.com, www.musicsearch.com, www.musicseek.net, www.audiofind.com.

There are no existing methodologies or systems that allow music searchers to search for digitized music based on the melody and rhythm of the music. This invention provides such a methodology and system to achieve melody and rhythm based search.

### SUMMARY

This invention provides a methodology and system to search music information over a computer network, especially the Internet, based on melody and rhythm of the music.

Objects and Advantages

The objective of this invention is to provide such a method to search music over computer network and the Internet without the knowledge of any textual information of a piece of music.

This invention can be valuable while a music searcher only knows the melody and/or rhythm of a piece of music. It is also valuable while no textual information of a piece of music is available in a language that the searcher knows of, e.g. for a music searcher who is only an English speaker to search a Chinese song in a Chinese based system.

### DRAWING FIGURES

FIG. 1 shows architecture for a melody and rhythm based music searching system.

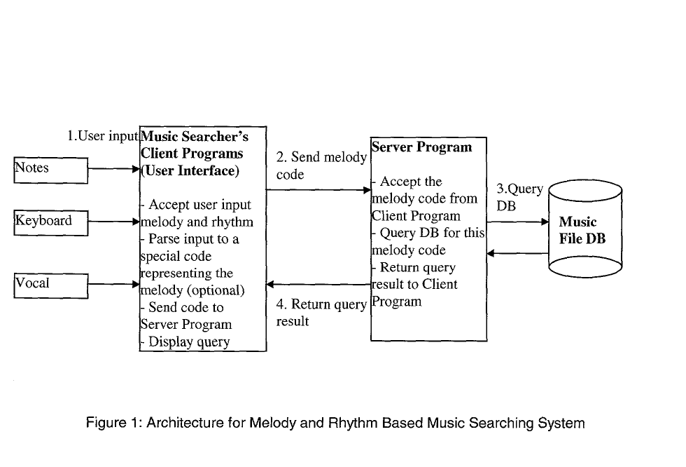

FIG. 2 show the screenshot of music searcher's user interface.

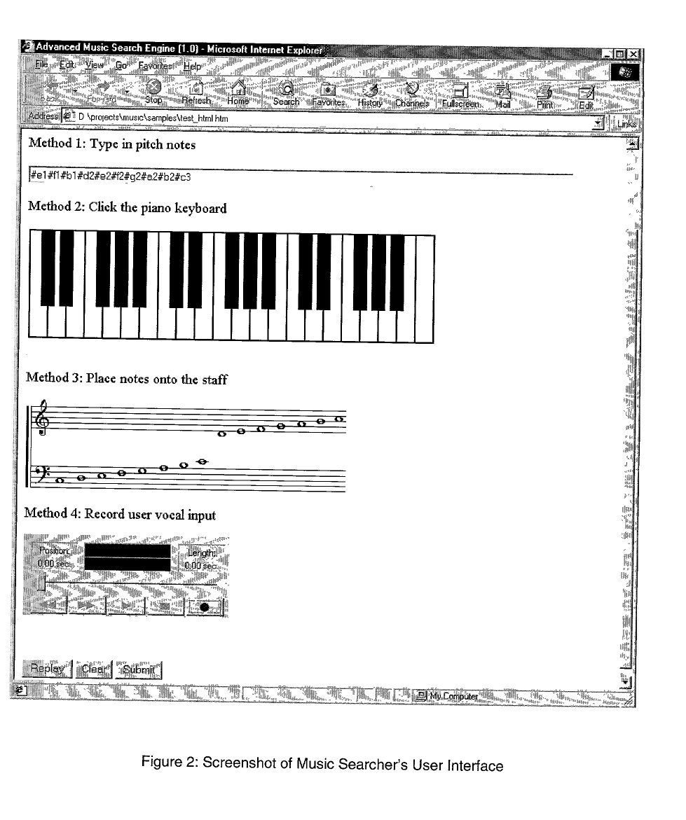

### REFERENCE NUMERALS IN DRAWINGS

Not applicable.

### DESCRIPTION

The system is composed of the following three components, database, client programs and server programs.

Music and Music Provider Information Database

The database stores the following information as a minimum.

Music Information with Melody/Rhythm Key Index

As a minimum, information for each music should include: title of the music, a digital music record or link to a digital music record (such as an HTML hyperlink), a special code sequence (e.g. a sequence of pitch notes such as C0, D0, E0, F0, A0, B0 or a sequence of integers) that represents the main melody and/or rhythm of the music.

Music Provider Information

As a minimum, information for each music provider should include: name of the music provider, contact information, and other administrative information.

Cross-Reference between Music Provider and Music

This stores information about which provider offers which piece of music or information for that music.

Client Programs

Client Programs serve as interface between the system and users. In this system there are two types of client programs, one for music searchers, and the other for music providers.

Music Searcher's Client Program

This is the computer program that runs on a music searcher's computer. It serves as the interface for a music searcher to input the melody and/or rhythm that he or she would like to search for. It then queries the Server Program and presents the answer from the Server Program to the user. The major functions of the Client Programs should include

Providing an interface for the user to input the melody

Translating the user input into a melody/rhythm key with a special format (optional)

Sending the melody/rhythm key to the Server Program

Receiving the query result from the Server Program and presenting it to the user

The following describes each of the above functions and their implementation in detail.

1. Providing an Interface for the User to Input the Melody

It provides a way that the user inputs the melody that he/she would like to search for.

This is the process that transforms the music melody into digital format that can be stored and processed by computer. For example, user can hum the music to a microphone attached to a computer, record music scores on a staff as if composing music on a compute screen, or play the music on a simulated music instrument on the computer screen.

The input data is stored in the memory of the local computer in a proper format, depending on which input technology is used. For example, it could be stored as a binary sequence, or a sequence of pitch notes in text format. The user interface also allows the user to replay, edit, clear, re-enter and submit the input.

One possible implementation of the Client Programs is to embed Java Applet and JavaScript in an HTML page. User may use one or many of the following ways to input the melody/rhythm.

Typing a sequence of pitch notes (e.g. “C1#D1#E1#C1#E1#C1#E1#D1#E1”) in text field

User may use some delimiter, e.g. ‘#’, to separate two notes. Repetitively appearing of a same note, or the appearing of some special note, such as “-”, can be used to represent a prolonged notes, and intervals within the music, i.e. rhythm of the music. This functionality can be implemented using HTML Form tags and JavaScript.

Playing the simulated music instrument on the computer screen

User can use mouse, keyboard, other pointing device connected to the computer, or finger in the case of using a touch-screen, to play a simulated music instrument on computer screen. The keyboard on the screen and the user interaction functionality can be implemented using HTML image map and JavaScript or Java Applet. The operation of the computer sound device can be implemented using Java Applet.

Placing notes to a staff on the computer screen

User can use mouse, keyboard, other pointing device connected to the computer, or finger in the case of using a touch-screen, to interact with a staff on a computer screen. User can create or delete notes on the staff by drag and drop. This functionality can be implemented using Java Applet.

Vocal input (Humming)

The Client Program operates the sound device (such as computer sound card with microphone attached) of user's computer to allow user vocally input (such as singing, tapping or humming) the melody. This functionality can be implemented using Java Applet, or through other external software processes, e.g. Sound Recorder comes with Microsoft Windows Operating System.

2. Translating the User Input into a Melody/Rhythm Key with a Special Format (Optional)

When the Client Program accepts the user input, it parses the raw data and translates it into a special formatted code, the melody/rhythm key. When the data is sent to the Server Program, this key can be used to search the database. The Server Program compares the key with the key stored in database to look for matches. This step is optional because if the Server Program is able to use the raw data to do the comparison directly, this step can be skipped. This step can be performed by Server Program instead, in which case the Client Program sends the raw input data to the Server Program directly.

3. Sending the Melody/Rhythm Key to the Server Program

A bi-directional connection is established between the Client Program and the Server Program. In the case where Client Programs are implemented as HTML pages, it is usually an HTTP connection between the web browser and the Server Program, The Client Program sends melody key or raw input data to the Server Program over this connection.

4. Receiving the Query Result from the Server Program and Presenting it to the User

Client Program receives the searching result from the Server Program over the above connection. The searching results are formatted and presented to the user through the user interface.

Music Provider's Client Program

This is the computer program that runs on a music provider's computer. It serves as the interface for music providers to store music records, music information or links to above information in the database. By providing similar capability as Music Searcher's Client Program, it allows music providers to create melody/rhythm keys. In addition, it offers music providers the capability to manage administrative information.

Providing an interface for music providers to input and maintain administrative information

Allowing music providers to upload music records, music information or links to the above into the database

Translating input melody or the entire music record into a melody/rhythm key with a special format (optional)

Sending information mentioned above to the Server Program

The following describes each of the above functions and their implementation in detail.

1. Providing an Interface for Music Providers to Input and Maintain Administrative Information

It provides a way that the music providers input and maintain administrative information such as user name, password, contact information, etc.

2. Allowing Music Providers to Upload Music Records, Music Information or Links to the Above into the Database

Through Client Programs, music providers can upload digital music records of different format into the database. They can also upload information related to a piece of music into the database, such as title, artist, lyric, category, etc. Or they can choose to upload links (e.g. HTML hyperlinks) to where (e.g. a URL) they store the above information or records.

3. Translating Input Melody or the Entire Music Record into a Melody/Rhythm Key with a Special Format (Optional)

Music providers create melody/rhythm keys in the database. To input a melody/rhythm key into the database, similar input method as that for Music Searcher's Client Program can be used. Addition to these, digital music records can be translated to melody/rhythm key directly. This function is optional because it can be performed by Server Program instead.

4. Sending Information Mentioned above to the Server Program

A connection is established between the Client Program and the Server Program. In the case where Client Programs are implemented as HTML pages, it is usually a HTTP connection between the web browser and the Server Program. The Client Program sends the above information to Server Program over this connection.

Server Programs

Server Programs are computer programs that run on a server computer. The major functions of server programs include providing services for music searchers and providing services for music providers. Server Programs can be implemented using C, Perl, Java or other programming languages, specifically in the form of CGI program, Servlet, Java Server Page (JSP), Active Server Page (ASP) and other server side programming technologies, together with a general purpose web server which supports any or all of above server side programming technologies.

Services for Music Searchers

Receiving data from the music searchers' client program

Translating the data into a special formatted code (optional)

Searching the database with the formatted code as a key

Returning the query result to the Client Program

The following describes these functions in detail.

1. Receiving Data from the Client Program

A bidirectional connection is established between the Client Program and the Server Program. The server program receives the raw data or melody/rhythm code from the Client.

2. Translating the Data into a Special Formatted Code (Optional)

If the data received from the Client Program is raw data (the Client Program has not perform any translation yet), depending on the comparison algorithm and the key format the Server Program uses when querying the database, the Server Program parses the data into some special formatted melody/rhythm key. This step may be skipped if the Server Program can use the raw input data as a key to query the database or the Client Program has done the parsing.

3. Searching the Database using Melody/Rhythm Key or Raw Input Data

Computer program that resides in the database, such as database stored procedures, compare the melody/rhythm key or raw input data with the melody/rhythm key or digital music record stored in the database. If a match is found, the corresponding music record and other music information will be retrieved.

4. Returning the Query Result to the Client Program

If the query is successful, the Server Program organizes the query results in a proper format. The query result is sent to the Client Program through the above connection.

Services for Music Providers

Receiving data from the music providers' client program

Validating data from the music providers' client program

Storing data into the database

Translating the data into a special formatted code (optional)

The following describes these functions in detail.

1. Receiving Data from the Music Providers' Client Program

A connection is established between the Client Program and the Server Program. The server program receives music provider related information, music records, music related information or links to the above.

2. Validating Data from the Music Providers' Client Program

Some information passed from Client Program needs to be validated, e.g. password, contact information, etc.

3. Storing Data into the Database

Server Programs connect to the database and store valid information and data into database.

4. Translating the Data into a Special Formatted Code (Optional)

Server Program may need to store music/melody key into database if the searching is not based on raw digital music record. It translates the input melody/rhythm data or the music record itself into music/melody key. Similarly it is an optional function since translation may have been done by Music Providers Client Programs.

Music Melody/Rhythm Key

A possible implementation for music melody and rhythm key is to use a note string (a sequence of pitches) that represents the main melody scale and rhythm (meter) of the music, for example, “#c1#d1#e1#c1#e1#c1#e1#d1#e1#f1#f1#e1#d1#f1#e1#f1#g1#e1#g1#e1#g1#f1#g1#a1#a1#g1#f1#a1” (part of the main melody of Sound of the Music). “#” serves as the delimiter between two notes in this example. Repetitively appearing of a same note, or the appearing of some special note, such as “-”, can be used to represent a prolonged notes, and intervals within the music.

The melody/rhythm key described above can be transcribed from a piece of music by three methods: manual, automatic and semi-automatic.

Using the manual method, the melody/rhythm keys are generated by simply typing in the key string.

Using the semi-automatic method, user uses the simulated music instrument mentioned above to play the music. The melody/rhythm key is generated by the component described in Client Programs.

Using the automatic method, melody/rhythm key is generated directly from the digital music record. The detail of automatic transcription is not in the scope of this document.

Music Key Matching Algorithm

To match the melody/rhythm key that represents music searcher's input with the melody/rhythm key stored in the database requires some matching algorithm. Two possible matching algorithms are described below.

Exact sequence match

Compare the input key with the stored key, if the input key is a sub sequence of the stored key, a match is found. This method can be implemented by standard database query function, e.g. LIKE clause in SQL.

Difference Variation Computation

Both the input key and stored key are transferred to a sequence of linearly comparable quantities, e.g. integers. The following is an example: stored key is 1, 2, 3, 2, 4, 5, 6, 7, 6 and the input key is 2, 4, 5, 6.

Starting from the left most value of the stored key, the input key is compared with the segment of the stored key to achieve a sequence of the difference. The variance of the sequence is further calculated as the matching criteria. If the variance is less than a pre-defined threshold, a match is found, and the algorithm is stopped. Otherwise shift to the next value within the stored key and repeat this calculation until a match is found or the end of the stored key is reached. In this example, once the input key is shifted to the fourth integer of the stored key, the difference sequence is (0, 0, 0, 0), which gives a variance of 0, therefore a match is found and the comparison is finished.

Operation

Music Searcher's Operation

Music searchers input the melody/rhythm through the Client Programs. Following are some possible ways for the user to input the melody. User can choose one of these approaches, or a combination of two or more, to input the melody:

Typing a Sequence of Pitch Notes (e.g. “C1#D1#E1#C1#E1#C1#E1#D1#E1”) in Text Field

User may use some delimiter, e.g. ‘#’, to separate two notes. Repetitively appearing of a same note, or the appearing of some special note, such as “-”, can be used to represent a prolonged notes, and intervals within the music.

Clicking on a Simulated Music Instrument on the Computer Screen

User can use mouse, keyboard, other pointing device connected to the computer, or finger in the case of using a touch-screen, to interact with the simulated music instrument on computer screen.

Clicking and Place Notes to a Staff on the Computer Screen

User can use mouse, keyboard, other pointing device connected to the computer, or finger in the case of using a touch-screen, to interact with a staff on a computer screen.

User can create or delete notes on the staff by drag and drop. This functionality can be implemented using Java Applet.

Vocally Inputting the Melody

The Client Program operates the sound device (such as microphone) of user's computer to allow user vocally input (such as singing, tapping or humming) the melody. This functionality can be implemented using Java Applet, or through other external software processes, e.g. Sound Recorder comes with Microsoft Windows Operating System.

Through the Client Program, music searcher can replay and modify the melody/rhythm he or she just entered. After clicking a Submit button, the input will be sent to Server Programs. If any matching results are found, the searching result will be displayed to the music searcher in certain format, such as an HTML page.

Music Provider's Operation

Music providers store music records, music information or links to above information, and other related administrative information about the music provider in the database. This could be accomplished by submitting the above information through an HTML form from a web browser.

Conclusion, Ramification, and Scope

Accordingly, this invention provides a methodology and system to search music information over a computer network, especially the Internet, based on melody and rhythm of a piece of music, without the knowledge of any textual information of the music.

This invention can be valuable while a music searcher only knows the melody and/or rhythm of a piece of music. It is also valuable while no textual information of a piece of music is available in a language that the searcher knows of, e.g. for a music searcher who is only an English speaker to search a Chinese song in a Chinese based system.

Although the description above contains possible technologies for implementation, these should not be constructed as limiting the scope of the invention but as merely providing illustrations of some of the presently preferred embodiment of this invention.

Thus the scope of the invention should be determined by the appended claims and their legal equivalents, rather than by the examples given.

List 1. MusicSearchEngine.java
package melody;
import java.sql.*;
import java.util.*;
import oracle.jdbc.driver.*;
public class MusicSearchEngine {

private static final String dbURL

= “jdbc:oracle:thin:mel/mel@localhost:1521:melody”;

private static Connection con;
private Hashtable checkTable;
public MusicSearchEngine(){

//establish connection to DB
try{

DriverManager.registerDriver(new OracleDriver());
con = DriverManager.getConnection(dbURL);
con.setAutoCommit(false);

}catch(SQLException sqlE){

System.out.println(“MusicSearchEngine establish DB connection throws: ” + sqlE);

}
checkTable = new Hashtable();
checkTable.put(“c0”,new Integer(1));
checkTable.put(“cs0”,new Integer(2));
checkTable.put(“d0”,new Integer(3));
checkTable.put(“ds0”,new Integer(4));
checkTable.put(“e0”,new Integer(5));
checkTable.put(“f0”,new Integer(6));
checkTable.put(“fs0”,new Integer(7));
checkTable.put(“g0”,new Integer(8));
checkTable.put(“gs0”,new Integer(9));
checkTable.put(“a0”,new Integer(10));
checkTable.put(“as0”,new Integer(11));
checkTable.put(“b0”,new Integer(12));
checkTable.put(“c1”,new Integer(13));
checkTable.put(“cs1”,new Integer(14));
checkTable.put(“d1”,new Integer(15));
checkTable.put(“ds1”,new Integer(16));
checkTable.put(“e1”,new Integer(17));
checkTable.put(“f1”,new Integer(18));
checkTable.put(“fs1”,new Integer(19));
checkTable.put(“g1”,new Integer(20));
checkTable.put(“gs1”,new Integer(21));
checkTable.put(“a1”,new Integer(22));
checkTable.put(“as1”,new Integer(23));
checkTable.put(“b1”,new Integer(24));
checkTable.put(“c2”,new Integer(25));
checkTable.put(“cs2”,new Integer(26));
checkTable.put(“d2”,new Integer(27));
checkTable.put(“ds2”,new Integer(28));
checkTable.put(“c2”,new Integer(29));
checkTable.put(“f2”,new Integer(30));
checkTable.put(“fs2”,new Integer(31));
checkTable.put(“g2”,new Integer(32));
checkTable.put(“gs2”,new Integer(33));
checkTable.put(“a2”,new Integer(34));
checkTable.put(“as2”,new Integer(35));
checkTable.put(“b2”,new Integer(36));
checkTable.put(“c3”,new Integer(37));

}
public MusicEntry[] getMusicEntries(String inputMelKeySeq) {

MusicEntry[] mev;
// SQL for exact match
try{

Statement stmt = con.createStatement();
Sting querySQL = “SELECT me.MUSIC_ENTRY_ID ” +

“me.MUSIC_NAME, ” +
“me.MUSIC_KEY, ” +
“mp.USER_NAME, ” +
“pmc.MUSIC_ENTRY_URL, ” +
“pmc.COMMENTS, ” +

“mp.MAIN_WEBSITE_URL ” +

“FROM ” +
“ml_music_entries me, ” +
“ml_music_providers mp, ” +
“ml_provider_music_crfs pmc ” +
“WHERE ” +
“me.music_entry_id = pmc.musics_entry_id (+) ” +
“AND pmc.user_id = mp.user_id (+) ” +
“AND me.music_key_sequence LIKE ‘%” + inputMelKeySeq +

“%”’;

System.out.println(querySQL);
ResultSet rs = stmt.executeQuery(querySQL);
Vector tmp Vector = new Vector();
while (rs.next()){

MusicEntry me = new MusicEntry();
me.setEntryID(rs.getString(1));
me.setEntryName(rs.getString(2));
me.setMusicKey(rs.getString(3));
me.setProviderName(rs.getString(4));
me.setEntryProviderURL(rs.getString(5));
me.setEntryProviderComment(rs.getString(6));
me.setProviderURL(rs.getString(7));
tmpVector.addElement(me);

}
mev = new MusicEntry[tmpVector.size()];
for (int = 0; i< tmpVector.size(); ++i){

mev[i] = (MusicEntry)tmpVector.elementAt(i);

}
if(tmpVectorsize() > 0){

// if exact match SQL found something, return the result
return (mev);

}

}catch(SQLException sqlE){

System.out.println(“MusicSearchEngine query DB [EXACT] throws: ” + sqlE);
mev = new MusicEntry[0];
return (mev);

}
// SQL for fuzzy match, only executed when exact match returns 0 record
try{

Statement stmt = con.createStatement();
// this sql calls java/stored procedure
String querySQL = “SELECT me.MUSIC_ENTRY_ID, ” +

“me.MUSIC_NAME, ” +
“me.MUSIC_KEY, ” +
“mp.USER_NAME, ” +
“pmc.MUSIC_ENTRY_URL ” +
“pmc.COMMENTS, ” +

“mp.MAIN_WEBSITE_URL ” +

“FROM ” +
“ml_music_entries me, ” +
“ml_music_providers mp, ” +
“ml_provider_music_crfs pmc ” +
“WHERE ” +
“me.music_entry_id = pmc.music_entry_id (+) ” +
“AND pmc.user_id = mp.user_id (+) ” +
“AND

ml_music_searcher.match_sequence(me.MUSIC_KEY_SEQUENCE, ”’

+ inputMelKeySeq + ”’) = ‘Y’”;

System.out.println(querySQL);
ResultSet rs = stmt.executeQuery(querySQL);
Vector tmpVector = new Vector();
while (rs.next()){

MusicEntry me = new MusicEntry();
me.setEntryID(rs.getString(1));
me.setEntryName(rs.getString(2));
me.setMusicKey(rs.getString(3));
me.setProviderName(rs.getString(4));
me.setEntryProviderURL(rs.getString(5));
me.setEntryProviderComment(rs.getString(6));
me.setProviderURL(rs.getString(7));
tmpVector.addElement(me);

}
mev = new MusicEntry[tmpVector.size()];
for (int i = 0; i< tmpVector.size(); ++i){

mev[i] = (MusicEntry)tmpVector.elementAt(i);

}
return (mev);

}catch(SQLException sqlE){

System.out.println(“MusicSearchEngine query DB [FUZZY] throws : ” + sqlE);
mev = new MusicEntry[0];
return (mev);

}

}
public MusicEntry[] getMusicEntriesForTarget(MusicEntry targetEntry, String providerName) {

MusicEntry[] mev;
String musicKey;
String entryName;
String category;
String subCategory;
String artists;
String lyric;
String language;
String country;
if (targetEntry.getMusicKey() == null ||

targetEntry.getMusicKey().equalsIgnoreCase(“null”))
musicKey = “”;

else

musicKey = targetEntry.getMusicKey();

if (targetEntry.getEntryName() == null ||

targetEntry.getEntryName().equalsIgnoreCase(“null”))
entryName = “”;

else

entryName = targetEntry.getEntryName();

if(targetEntry.getCategory() == null ||
targetEntry.getCategory().equalsIgnoreCase(“null”))

category = “”;

else

category = targetEntry.getCategory();

if(targetEntry.getSubCategory() == null ||
targetEntry.getSubCategory().equalsIgnoreCase(“null”))

subCategory = “”;

else

subCategory = targetEntry.getSubCategory();

if(targetEntry.getArtists() == null ||
targetEntry.getArtists().equalsIgnoreCase(“null”))

artists = “”;

else

artists = targetEntry.getArtists();

if(targetEntry.getLyric() == null ||
targetEntry.getLyric().equalsIgnoreCase(“null”))

lyric = “”;

else

lyric = targetEntry.getLyric();

if(targetEntry.getLanguage() == null ||
targetEntry.getLanguage().equalsIgnoreCase(“null”))

language = “”;

else

language = targetEntry.getLanguage();

if(targetEntry.getCountry() == null ||
targetEntry.getCountry().equalsIgnoreCase(“null”))

country = “”;

else

country = targetEntry.getCountry();

// SQL for exact match
try{

Statement stmt = con.createStatement();
String querySQL = “SELECT DISTINCT me.MUSIC_ENTRY_ID, “ +

“me.MUSIC_NAME, ” +
“me.MUSIC_KEY, ” +
“mp.USER_NAME, ” +
“DECODE(mp.USER_NAME, “‘ + providerName + ”’,

pmc.MUSIC_ENTRY_URL, ”),” +

“pmc.COMMENTS, ” +

“mp.MAIN_WEBSITE_URL ” +

“FROM ” +
“ml_music_entries me, ” +
“ml.music_providers mp, ” +
“ml.provider_music_crfs pmc ” +
“WHERE ” +
“me.music_entry_id = pmc.music_entry_id (+) ” +
“AND pmc.user_id = mp.user_id (+) ” +
“AND mp.user_name (+) = “” + providerName + “” +
“AND me.music_key LIKE ‘%” + musicKey + “%’ ” +
“AND me.music_name LIKE ‘%” + entryName + “%’ ” +
“AND me.MUSIC_CATEGORY LIKE ‘%” + category + “%’ ” +
“AND me.SUB_CATEGORY1 LIKE ‘%” + subCategory + “%’ ” +
“AND me.ARTISTS LIKE ‘%” + artists + “%’ ” +
“AND me.LYRIC LIKE ‘%” + lyric + “%’ ” +
“AND me.MUSIC_LANGUAGE LIKE ‘%” + language + “%’ ” +
“AND me.COUNTRY LIKE ‘%” + country + “%’ ”;

System.out.println(querySQL);
ResultSet rs = stmt.executeQuery(querySQL);
Vector tmpVector = new Vector();
while (rs.next()){

MusicEntry me = new MusicEntry();
me.setEntryID(rs.getString(1));
me.setEntryName(rs.getString(2));
me.setMusicKey(rs.getString(3));
me.setProviderName(rs.getString(4));
me.setEntryProviderURL(rs.getString(5));
me.setEntryProviderComment(rs.gesString(6));
me.setProviderURL(rs.getString(7));
tmpVector.addElement(me);

}
mev = new MusicEntry[tmpVector.size()];
for (int i = 0; i< tmpVector.size(); ++i){

mev[i] = (MusicEntry)tmpVector.elementAt(i);

}
return (mev);

}catch(SQLException sqlE){

System.out.println(“MusicSearchEngine query DB [EXACT] throws : ” + sqlE);
mev = new MusicEntry[0];
return (mev);

}

}
public MusicEntry[] getMusicEntriesForUser(String userName) {

MusicEntry[] mev;
try{

Statement stmt = con.createStatement();
String querySQL = “SELECT me.MUSIC_ENTRY_ID, ” +

“me.MUSIC_NAME, ” +
“me.MUSIC_KEY, ” +
“mp.USER_NAME, ” +
“pmc.MUSIC_ENTRY_URL, ” +
“pmc.COMMENTS, ” +

“mp.MAIN_WEBSITE_URL ” +

“FROM ” +
“ml_music_entries me, ” +
“ml_music_providers mp, ” +
“ml_provider_music_crfs pmc ” +
“WHERE ” +
“me.music_entry_id = pmc.music_entry_id (+) ” +
“AND pmc.user_id = mp.user_id (+) ” +
“AND mp.user_name = “‘ + userName + ”’ ” +
“AND me.created_by_id = mp.user_id ” +
“ORDER BY UPPER(me.MUSIC_NAME)

System.out.println(querySQL);
ResultSet rs = stmt.executeQuery(querySQL);
Vector tmpVector = new Vector();
while (rs.next()){

MusicEntry me = new MusicEntry();
me.setEntryID(rs.getString(1));
me.setEntryName(rs.getString(2));
me.setMusicKey(rs.gesString(3));
me.setProviderName(rs.getString(4));
me.setEntryProvidcrURL(rs.getString(5));
me.setEntryProviderComment(rs.getString(6));
me.setProviderURL(rs.getString(7));
tmpVector.addElement(me);

}
mev = new MusicEntry[tmpVector.size()];
for (int i = 0; i< tmpVector.size(); ++i){

mev[i] = (MusicEntry)tmpVector.elementAt(i);

}
return (mev);

}catch(SQLException sqlE){

System.out.println(“MusicSearchEngine query DB [EXACT] throws : ” + sqlE);
mev = new MusicEntry[0];
return (mev);

}

}
public String getKeySequence(String musicKey){

String checkNote1;
String checkNote2;
// ‘-’ is the rhythm pause symbol, ‘#’ is delimiter beteween notes
musicKey = musicKey.replace(‘-’, ‘#’); //remove the rhythm dash
StringTokenizer stMelody = new StringTokenizer(musicKey, “#”);
musicKey = “”;
checkNote1 = stMelody.nextToken();
// in this while loop, melody string is modified to ignore repeating notes
// e.g. “c1#c1#c1#a1#b1#b1” −> “c1#a1#b1”
while(stMelody.hasMoreTokens()){

checkNote2 = stMelody.nextToken();
if(!checkNote1.equals(checkNote2))
{

musicKey = musicKey + checkNote1 + “#”;

}
checkNote1 = checkNote2;

{
musicKey = musicKey + checkNote1;
stMelody = new StringTokenizer(musicKey, “#”);
musicKey = “”;
int noteCount = stMelody.countTokens();
double[] noteSeq = new double[noteCount];
int i = 0;
// in this while loop, the number sequence is created using a NoteChecker object
while (stMelody.hasMoreTokens()){

noteSeq[i] = (double)((Integer)checkTable.get(stMelody.nextToken())).intValue();
musicKey = musicKey + (new Integer((int)noteSeq[i])).toString() + “#”;
i++;

}
return musicKey;

}

}
List 2. MusicSearchDBComp.java
import java.sql.*;
import java.util.*;
import oracle.jdbc.driver.*;
public class MusicSearchDBComp{

private static double accuracy = 1;
public static String matchSequence(String musicKeySeq, String inputMelSeq){

double [] musicDoubleArr = getDoubleArr(musicKeySeq);
double [] inputDoubleArr = getDoubleArr(inputMelSeq);
double [] diffDoubleArr = new double[inputDoubleArr.length];
for (int songPosition = 0;

songPosition < musicDoubleArr.length − inputDoubleArr.length + 1;
songPosition ++){
//Loop through input numbers
for(int i = 0; i< inputDoubleArr.length; ++i){

diffDoubleArr[i] = abs(inputDoubleArr[i] − musicDoubleArr[songPosition + i]);

}
//System.out.println(variance(diffNumbers));
if (variance(diffDoubleArr) <accuracy){ // Match !!!

return “Y”;

}

}
return “N”;

}
// compute variance of an array
// formula: 1/(n−1)*SUM(xi − xmean)²

private static double variance(double[] doubleArray)

{

int arrayLength = doubleArray.length;
double sum =0;
double mean;
for (int i = 0; i<arrayLength; ++i)
{

sum += doubleArray [i];

}
mean = sum/arrayLength;
sum = 0;
for (int i = 0; i<arrayLength; ++i)
{

sum += (doubleArray [i] - mean)*(doubleArray [i] - mean);

}
return (sum/(arrayLength−1));

}
private static double abs(double a)
{

if (a<0)

return −a;

else return a;

}
private static double[] getDoubleArr(String keySeq){

StringTokenizer stMelody = new StringTokenizer(keySeq, “#”);
int noteCount = stMelody.countTokens();
double[] noteSeq = new double[noteCount];
int i =0;
// in this while loop, the number sequence is created using a NoteChecker object
while (stMelody.hasMoreTokens()){

noteSeq[i] = (double)(Integer.parseInt(stMelody.nextToken()));
i++;

}
return noteSeq;

}

}
// Commands to load class into DB: DON'T DELETE
// create or replace directory bfile_dir as ‘/projects/tmp’;
// create or replace java class using bfile(bfile_dir, ‘MusicSearchDBComp.class’);
// dbms_output.put_line(ml_music_searcher.match_sequence(‘afads’,‘sfaf’));

We claim:

1. A system of searching for music on a computer network based on melody and rhythm of said music, comprising:
(a) a database on a computer or a group of computers connected to the said computer network
(b) computer processes allowing music searchers to input melody and rhythm and communicating with said database and performing a searching process in said database for said input melody and rhythm and displaying searching results to said music searchers.

2. The system of claim 1 wherein said computer network is the Internet.

3. The system of claim 1 wherein said database stores music melody and rhythm sequence and digital music records or links to digital music records or textual music information and other related music provider information.

4. The system of claims 3 wherein said music melody and rhythm sequence is in the form of a sequence of text characters representing notes and pause within a piece of music.

5. The system of claim 1 wherein said searching process comprises:
(a) transferring said input melody and rhythm sequence to a sequence of any linearly comparable quantities,
(b) transferring the melody and rhythm sequence stored in said database to a sequence of said linearly comparable quantities,
(c) starting from first value of said sequence of said linearly comparable quantities for melody and rhythm stored in said database,
(d) calculating difference of each pair of corresponding quantities of said input sequence of said linearly comparable quantities and said sequence of said linearly comparable quantities for melody and rhythm stored in said database,
(e) calculating variance of the resulting sequence of (d),
(f) returning a flag for match if said variance is less than a pre-defined threshold,
(g) shifting to next value of said sequence of said linearly comparable quantities for melody and rhythm stored in said database,
(h) continuing (d) to (g) until reaching the end of said sequence of said linearly comparable quantities for melody and rhythm stored in said database.

6. The system of claim 1 wherein said searching process comprises:
(a) transferring said input melody and rhythm to a sequence of characters representing notes and pause within said input melody and rhythm,
(b) comparing said input melody and rhythm sequence to melody and rhythm sequence stored in said database,
(c) returning a flag for match if said input sequence is a sub sequence of said melody and rhythm sequence stored in said database.

7. The system of claim 1 wherein said method of transforming music melody and rhythm to melody and rhythm sequence, comprising:
(a) an input field on computer screen allowing said music searcher to type in said melody and rhythm sequence,
(b) a simulated music instrument on computer screen allowing said music searcher to play said melody and rhythm,
(c) a staff on computer screen allowing said music searcher to place notes on said staff to represent said melody and rhythm,

8. The system of claim 7 wherein said simulated music instrument on computer screen is implemented by HTML image map and Java Applet.

9. The system of claim 7 wherein said staff on computer screen is implemented by HTML image map and Java Applet.
